(19) United States
(12) Patent Application Publication
(10) Pub. No.: US 2025/0000050 A1
(43) Pub. Date: Jan. 2, 2025

(54) NEAR NEUTRAL PH WHITE CLUMPING LITTER

(71) Applicant: THE CLOROX COMPANY, Oakland, CA (US)

(72) Inventor: Ahmed DRIEF, Pleasanton, CA (US)

(21) Appl. No.: 18/742,203

(22) Filed: Jun. 13, 2024

Related U.S. Application Data
(60) Provisional application No. 63/510,717, filed on Jun. 28, 2023.

(51) Int. Cl. A01K 1/015; B01J 20/20; B01J 20/24; B01J 20/28

(52) U.S. Cl. CPC A01K 1/0155; A01K 1/0154; B01J 20/20; B01J 20/24; B01J 20/28016

(57) ABSTRACT

A white clumping animal litter including a pH health indicator, the animal litter including (i) a particulate substrate that is white, and has a substantially neutral pH, wherein the particulate substrate is configured to provide clumping of such particles when wetted during use; and (ii) pH health indicator particles admixed with the white substrate particles. The pH health indicator particles are of a first color when wetted with a substantially neutral pH liquid (e.g., normal pH cat urine), change to a second color different from the first color when wetted with a liquid having an acidic pH (e.g., abnormally acidic pH cat urine), and change to a third color, when wetted with a liquid having a basic pH (e.g., abnormally basic pH cat urine. The litter may exhibit excellent clumping characteristics, e.g., with a clump retention of at least about 90%.

### CROSS-REFERENCE TO RELATED APPLICATIONS

The present application claims the benefit of U.S. Provisional Patent Application Ser. No. 63/510,717, filed Jun. 28, 2023, entitled “NEAR NEUTRAL PH WHITE CLUMPING LITTER” the disclosure of which is incorporated by reference in its entirety.

### BACKGROUND OF THE INVENTION

### 1. The Field of the Invention

The present invention relates to litter for use by domestic animals. For example, such litter is typically employed by pet owners to absorb urine and collect feces.

### 2. Description of Related Art

Many people enjoy the company of one or more domestic pets. Litter boxes are typically provided for the use of such animals in the collection of urine and feces. Such a litter box is typically filled with an absorbent granular material (e.g., sand and/or clay), which aids in collecting the bodily wastes produced by pets. Some existing litter products provide “clumping” capability, by which the litter particles clump together when wetted (e.g., by urine). Sodium bentonite clay is often used in such clumping litter products. While clumping characteristics allow a user to easily remove used clumped litter portions, leaving adjacent unused litter product in the litter box for future use, existing clumping litters are generally based on use of bentonite clay, which is a non-renewable mineral resource.

Some litter products, e.g., FRESH STEP CRYSTALS HEALTH MONITOR are non-clumping, but provide a color-changing pH indicator, which can be helpful in early detection of potential health issues like UTIs or acidosis.

It would be an advancement in the art to provide litter products that were specifically configured to provide clumping, while at the same time also providing a color-changing pH health indicator. It would be further advantageous if such a litter product were formed entirely or substantially entirely from renewable (e.g., plant-based) sources, without the need for mined bentonite clay materials.

### BRIEF SUMMARY OF THE INVENTION

While there has been some effort to develop a plant-based litter product that would not require use of sodium bentonite or similar clumping mined mineral materials, such efforts have not met with significant success for several reasons. One particular problem with such renewable plant-based litter products is that if they clump at all, they tend to form clumps that are significantly inferior in strength to conventional sodium bentonite clumping clay litter products. In addition, even among renewable plant-based litter products that do clump, initial clump strength of such products is typically poor, requiring significant time to improve to an even somewhat acceptable value. In addition, as noted above, even after such time (e.g., 2-3 hours), existing renewable plant-based litter products typically exhibit final clump strength values that are inferior to those provided by sodium bentonite clumping clay litter products, which represent the “gold standard” for clump strength.

In addition, addition of pH health indicator particles to a clumping litter such as sodium bentonite clay particles is problematic, as such bentonite clay materials are not substantially neutral in pH, but exhibit an elevated pH, e.g., having a pH value of about 8-9. Such a non-neutral pH for the substrate material tends to mask the ability to detect whether the pH of the urine of the cat or other pet using the litter box is outside of the normal substantially neutral pH range (e.g., cat urine for a healthy cat is typically between 6.0 and 6.5). For example, if using a sodium bentonite litter substrate with added pH health indicator particles, if the cat or other pet's urine has a pH that is too acidic (e.g., less than 6.0), even if there are pH indicating particles within the litter composition, the basic bentonite clay substrate may neutralize the acidic urine, masking the ability of a user to see that the cat or other pet may be in need of intervention, to address the issue associated with acidic urine pH.

In addition to the problem of masking associated with use of bentonite clays as a substrate, it can be difficult to visually ascertain whether the pH health indicating particles blended with such a bentonite litter material have changed to a color that indicates the pet's urine may be too low or two high. This is because bentonite clay substrate materials are not white, but are gray or brown in color, making it difficult to determine whether there is an undesirable change in the color of the pH health indicating particles. Ideally, the litter substrate material providing a “canvas” or background for the color-changing pH health indicating particles would provide a substantially white canvas or background, rather than the noticeably brown or gray color associated with available bentonite clay materials.

Accordingly, an embodiment of the present application is directed to a white clumping animal litter including a pH health indicator, the animal litter comprising a particulate substrate that is white in color, and has a substantially neutral pH, wherein the particulate substrate is configured to provide clumping of such particles when wetted during use. The litter further includes pH health indicator particles (e.g., silica gel impregnated or otherwise provided with a color-changing pH indicator) that are admixed with the white substrate particles. The pH health indicator particles are of a first color (e.g., yellow) when wetted with a substantially neutral pH liquid (e.g., normal pH cat urine), wherein the pH health indicator particles are of a second color (e.g., orange and/or red), different from the first color, when wetted with a liquid having an acidic pH (e.g., abnormally acidic cat urine), and wherein the pH health indicator particles are of a third color (e.g., green and/or blue), different from the first and second colors, when wetted with a liquid having a basic pH (e.g., abnormally basic cat urine). Furthermore, the litter may advantageously exhibit a clump retention of at least 90%, providing clumping characteristics that are at least comparable to the clumping characteristics provided by conventional sodium bentonite litter.

Another embodiment is directed to a clumping animal litter formed from renewable components and including a pH health indicator, the animal litter including composite particles that are white, and include a substantially neutral pH, the composite particles being formed from starch (e.g., natural starch) and dextrin or another modified starch, agglomerated together into the composite particles. The dextrin or other modified starch comprises from about 10% to about 50% by weight of the composite particles and the starch (e.g., natural unmodified starch) comprises from about 50% to about 90% by weight of the composite particles. The litter also includes pH health indicator particles (e.g., silica gel impregnated or otherwise provided with a color-changing pH indicator) that are admixed with the white composite particles. The pH health indicator particles are of a first color (e.g., yellow) when wetted with a substantially neutral pH liquid (e.g., normal pH cat urine), wherein the pH health indicator particles are of a second color (e.g., orange and/or red), different from the first color, when wetted with a liquid having an acidic pH (e.g., abnormally acidic cat urine), and wherein the pH health indicator particles are of a third color (e.g., green and/or blue), different from the first and second colors, when wetted with a liquid having a basic pH (e.g., abnormally basic cat urine). The litter may be substantially free of non-renewable mineral components (e.g., bentonite or other clays). Furthermore, the litter may advantageously exhibit a clump retention of at least 90%, providing clumping characteristics that are at least comparable to the clumping characteristics provided by conventional sodium bentonite litter.

While described above where the pH health indicator particles are admixed with the composite particles, it is conceivable that the pH health indicator component(s) could be incorporated into the composite particles, in an embodiment.

Another embodiment is directed to a clumping animal litter formed from renewable components and including a pH health indicator, the animal litter comprising composite particles that are white, and include a substantially neutral pH that is from 6 to 7.5, or 6.5 to 7.5, the composite particles being formed from starch (e.g., natural starch) and dextrin or another modified starch, agglomerated together into the composite particles. The dextrin or other modified starch comprises from about 10% to about 50% by weight of the composite particles and the starch (e.g., natural unmodified starch) comprises from about 50% to about 90% by weight of the composite particles. The litter also includes pH health indicator particles (e.g., silica gel impregnated or otherwise provided with a color-changing pH indicator) that are admixed with the white composite particles. The pH health indicator particles are of a first color (e.g., yellow) when wetted with a substantially neutral pH liquid (e.g., normal pH cat urine), wherein the pH health indicator particles are of a second color (e.g., orange and/or red), different from the first color, when wetted with a liquid having an acidic pH (e.g., abnormally acidic cat urine), and wherein the pH health indicator particles are of a third color (e.g., green and/or blue), different from the first and second colors, when wetted with a liquid having a basic pH (e.g., abnormally basic cat urine). The litter may be substantially free of non-renewable mineral components (e.g., bentonite or other clays). The white composite particles can be included in the animal litter in an amount of from about 85% to about 95% (e.g., about 90%) by weight. The pH health indicator particles can be included in the animal litter in an amount of from about 5% to about 15% (e.g., about 10%) by weight. Furthermore, the litter may advantageously exhibit a clump retention of at least 90%, providing clumping characteristics that are at least comparable to the clumping characteristics provided by conventional sodium bentonite litter.

In any of the described embodiments, the pH health indicator particles may generally be included within the animal litter in an amount of from about 1% to about 25% by weight.

In any of the described embodiments, the pH health indicator particles may generally be included within the animal litter in an amount of from about 5% to about 15% by weight (e.g., about 10%).

In any of the described embodiments, the white substrate particles may generally be included within the animal litter in an amount of from about 75% to about 99% by weight.

In any of the described embodiments, the white substrate particles may generally be included within the animal litter in an amount of from about 85% to about 95% by weight (e.g., about 90%).

In any of the described embodiments, as described, the white substrate particles may comprise composite particles including starch and dextrin or another modified starch agglomerated together into the composite particles.

In any of the described embodiments, such composite particles may further include powdered activated carbon (e.g., in an amount of from about 0.1% to about 5%, or from 0.25% to about 3% by weight of the composite particles).

In any of the described embodiments, such composite particles may further include a preservative (e.g., to minimize or prevent mold or other spoilage growth on the starch components). Such a preservative may be included in an amount of up to 2% by weight of the composite particles.

In any of the described embodiments, the pH health indicator particles may comprise silica gel crystals impregnated or otherwise provided with a color-changing pH indicator, that is color changing within the stated pH range (e.g., indicating one color at pH values of less than a pH of about 6 (corresponding to abnormally acidic cat urine), indicating another color at pH values of greater than about 6.5 (corresponding to abnormally basic cat urine), and another color at substantially neutral pH (corresponding to the normal cat urine pH range of about 6.0 to 6.5).

In any of the described embodiments, substantially all components of the litter may be plant-based.

As described in Applicant's earlier U.S. Publication No. 2022/0400648, which is herein incorporated by reference in its entirety, Applicant has surprisingly found that a combination of starch and dextrin or similar modified starch powder materials can be agglomerated together to form composite particles of the agglomerated starch and dextrin or other modified starch components, where excellent clump strength, including initial clump strength, can be very high, e.g., substantially equal to or even better than that provided by a sodium bentonite clumping clay litter product. In an embodiment, clump strength (even initial clump strength) may be similar to or greater than that of a clay litter product, e.g., such as at least 1,000 g_{f}. By way of comparative example, a sodium bentonite clumping litter product may provide an initial clump strength of less than 1,000 g_{f} (e.g., about 750-800 g_{f}), and may take 2-3 hours after initial dosing to reach a clump strength of 1,000 g_{f}. By way of additional comparison, such a sodium bentonite clumping litter product may provide a clump retention value of about 91%, while the present renewable plant-based litter products may provide clump retention of at least 90%, and may even exceed the clump retention provided by the comparative “gold standard” sodium bentonite clumping litter product. For example, the present renewable plant-based litter products may provide clump retention values of at least 91%, at least 92%, at least 93%, at least 94%, at least 95%, at least 96%, at least 97%, or at least 98%.

In an embodiment, the amount of the dextrin or similar modified starch may be greater than 10%, such as at least 12%, at least 15%, at least 16%, or at least 18%. In an embodiment, the dextrin or similar modified starch may be included in an amount of up to 50%, up to 40%, up to 35%, up to 30%, or up to 25%. The dextrin or similar modified starch component may have a relatively low molecular weight, significantly lower than that of the starch component. For example, the molecular weight of the dextrin or similar modified starch component may be less than 50,000 g/mol, less than 40,000 g/mol, less than 30,000 g/mol, at least 500 g/mol, or at least 1,000 g/mol, such as from 1,000 g/mol to 30,000 g/mol. The molecular weight of the starch may typically be far higher, e.g., greater than 100,000 g/mol, or greater than 1 million g/mol, such as several tens of millions or higher, for natural unmodified starches.

Because the present litter products are formed from starch and dextrin or similar modified starch, rather than typical mineral materials, the litter may have a bulk density value that is significantly lower than typical mineral-based litter products. For example, while mineral litter materials typically provide density values greater than 60 lb/ft³, or greater than 65 lb/ft³ (e.g., sodium bentonite clay has a density of about 68 lb/ft³), the present plant-based renewable litter products may have density values of less than about 60 lb/ft³, or less than about 50 lb/ft³, such as from about 30 lb/ft³ to about 50 lb/ft³.

In contrast to the litter product described in Applicant's U.S. Pat. No. 9,010,274, at least some embodiments of the present litter do not rely on inclusion of relatively large flat-shaped cellulosic materials (e.g., wood chips) as described therein. While in some embodiments, wood powder may be included, any such cellulosic wood powder material may be relatively small in particle size (e.g., powdered such as sawdust), rather than being present as relatively large wood chips. In addition, the litter product in U.S. Pat. No. 9,010,274 includes sodium bentonite clay as a coating material over the wood chips to achieve clumping, while the present litter products do not require use of any sodium bentonite to achieve clumping.

The composite particles used herein can be formed by agglomerating starch powder and dextrin or another modified starch powder with water using a pin mixer or similar high shear agglomeration process to form composite particles including the starch powder and modified starch powder agglomerated together into the composite particles. As described herein, such composite particles may include 10-50% by weight of the dextrin or similar modified starch, and 50-90% by weight of the higher molecular weight natural starch. Each composite particle includes both starch and modified starch, in contrast to a dry mixture of such components, where any given particle does not include both components. Substantially no mineral components (e.g., clays such as sodium bentonite, or sand, or limestone) may be present. In an embodiment, the agglomerated particles may further include powdered activated carbon (“PAC”), e.g., as an odor reducing agent, a preservative, or other desired adjunct. Such composite particles may be admixed with a small fraction (e.g., about 1-25%, such as about 10% by weight) of the pH health indicator particles, to provide the desired litter composition.

Further features and advantages of the present invention will become apparent to those of ordinary skill in the art in view of the detailed description of preferred embodiments below.

### BRIEF DESCRIPTION OF THE DRAWINGS

To further clarify the above and other advantages and features of the present invention, a more particular description of the invention will be rendered by reference to specific embodiments thereof which are illustrated in the drawings located in the specification. It is appreciated that these drawings depict only typical embodiments of the invention and are therefore not to be considered limiting of its scope. The invention will be described and explained with additional specificity and detail through the use of the accompanying drawings.

FIG. 1A shows a photograph of an exemplary substantially neutral pH litter according to the present invention.

FIG. 1B shows a photograph of a comparative litter including pH health indicator particles admixed with sodium bentonite, which is noticeably dark gray to brown in color, making identification of the yellow pH health indicator particles difficult.

FIG. 1C shows a photograph of another comparative litter including pH health indicator particles admixed with calcium bentonite particles which have been treated with soda ash, which while white to light gray in color, has a non-neutral, basic pH, which can mask any color change undergone by the initially yellow pH health indicator particles.

FIG. 2A shows a photograph of the substantially neutral pH litter of FIG. 1A, after dosing with an acidic solution with a pH of 4.5, where the initially yellow pH health indicator particles have changed to a high contrast, bright orange/red color in the wetted area.

FIG. 2B shows a photograph of the litter of FIG. 1B, after dosing with an acidic solution with a pH of 4.5, where any color change of the initially yellow pH health indicator particles to orange or red is difficult to perceive, given that the litter “canvas” against which such pH health indicator particles are viewed is dark gray to brown in color.

FIG. 2C shows a photograph of the litter of FIG. 1C, after dosing with an acidic solution with a pH of 4.5, where some of the color change of the initially yellow pH health indicator particles to orange or red is difficult to perceive, given that the litter “canvas” against which such pH health indicator particles are viewed is less white in color that that of FIGS. 1A and 2A. In addition, note that some of the pH health indicator particles have changed to green or blue due to the basic pH of the bentonite litter particles, which masks recognition of the applied solution as having an acidic pH.

FIG. 3A shows a photograph of the substantially neutral pH litter of FIG. 1A, after dosing with a substantially neutral pH solution (e.g., a pH of about 7), where the initially yellow pH health indicator particles have changed to a clear yellow or dull orange color, in the wetted area.

FIG. 3B shows a photograph of the litter of FIG. 1B, after dosing with a substantially neutral pH solution, it is difficult to perceive the pH health indicator particles against the sodium bentonite clay background, given that the background “canvas” is dark gray to brown in color.

FIG. 3C shows a photograph of the litter of FIG. 1C, after dosing with a substantially neutral pH solution, where any color change of the initially yellow pH health indicator particles to the wetted, clear yellow or orange color is more difficult to perceive as compared to FIG. 3A, given that the litter “canvas” against which such pH health indicator particles are viewed is less white in color that that of FIGS. 1A and 3A. In addition, note that some of the pH health indicator particles have changed to green or blue due to the basic pH of the bentonite litter particles, which confuses and masks recognition of the applied solution as having a substantially neutral pH.

FIG. 4A shows a photograph of the substantially neutral pH litter of FIG. 1A, after dosing with a basic solution having a pH of 9, where the initially yellow pH health indicator particles have changed to a dark blue color, in the wetted area.

FIG. 4B shows a photograph of the litter of FIG. 1B, after dosing with a basic solution having a pH of 9, where the pH health indicator particles have changed to a green color. The color change is more difficult to perceive that that exhibited in FIG. 4A.

FIG. 4C shows a photograph of the litter of FIG. 1C, after dosing with a basic solution having a pH of 9, where the pH health indicator particles have changed to a green and blue color.

FIG. 5 shows clump strength for two exemplary white, substantially neutral pH litter substrates that may be used according to the present invention, as well as various comparative examples.

FIG. 6 shows clump strength for exemplary white, substantially neutral pH litter substrates that may be used according to the present invention, formed at varying modified starch levels.

FIG. 7A shows clump weight for exemplary white, substantially neutral pH litter substrates that may be used according to the present invention, formed at varying modified starch levels.

FIG. 7B shows moisture content in the clump, formed at varying modified starch levels.

FIG. 8 shows clump strength for exemplary white, substantially neutral pH litter substrates formed with a variety of different plant material starches, at varying modified starch levels.

FIG. 9 shows strength ratio (clump strength to clump weight) for the same variety of different starch materials from FIG. 8, at varying modified starch levels.

FIG. 10 shows the mass of water needed for agglomeration at various levels of modified starch.

### DETAILED DESCRIPTION

### I. Definitions

Before describing the present invention in detail, it is to be understood that this invention is not limited to particularly exemplified systems or process parameters that may, of course, vary. It is also to be understood that the terminology used herein is for the purpose of describing particular embodiments of the invention only, and is not intended to limit the scope of the invention in any manner.

All publications, patents and patent applications cited herein, whether supra or infra, are hereby incorporated by reference in their entirety to the same extent as if each individual publication, patent or patent application was specifically and individually indicated to be incorporated by reference.

The term “comprising,” which is synonymous with “including,” “containing,” or “characterized by,” is inclusive or open-ended and does not exclude additional, unrecited elements or method steps.

The term “consisting essentially of” limits the scope of a claim to the specified materials or steps “and those that do not materially affect the basic and novel characteristic(s)” of the claimed invention.

The term “consisting of” as used herein, excludes any element, step, or ingredient not specified in the claim.

It must be noted that, as used in this specification and the appended claims, the singular forms “a”, “an” and “the” include plural referents unless the content clearly dictates otherwise. Thus, for example, reference to a “starch” includes one, two or more such starches.

Numbers, percentages, ratios, or other values stated herein may include that value, and also other values that are about or approximately the stated value, as would be appreciated by one of ordinary skill in the art. As such, all values herein are understood to be modified by the term “about”. A stated value should therefore be interpreted broadly enough to encompass values that are at least close enough to the stated value to perform a desired function or achieve a desired result, and/or values that round to the stated value. The stated values include at least the variation to be expected in a typical manufacturing process, and may include values that are within 10%, within 5%, within 1%, etc. of a stated value.

Some ranges may be disclosed herein. Additional ranges may be defined between any values disclosed herein as being exemplary of a particular parameter. All such ranges are contemplated and within the scope of the present disclosure.

In the application, effective amounts are generally those amounts listed as the ranges or levels of ingredients in the descriptions, which follow hereto. Unless otherwise stated, all percentages, ratios, parts, and amounts used and described herein are by weight, on a dry basis, e.g., so as to exclude any water content.

The phrase “free of”, “void of” or similar phrases if used herein means that the composition or article comprises 0% of the stated component, that is, the component has not been intentionally added. However, it will be appreciated that such components may incidentally form thereafter, under some circumstances, or such component may be incidentally present, e.g., as an incidental contaminant.

The phrase “substantially free of”, “substantially void of” or similar phrases as used herein means that the composition or article preferably comprises 0% of the stated component, although it will be appreciated that very small concentrations may possibly be present, e.g., through incidental formation, contamination, or even by intentional addition. Such components may be present, if at all, in amounts of less than 1%, less than 0.5%, less than 0.25%, less than 0.1%, less than 0.05%, less than 0.01%, less than 0.005%, less than 0.001%, or less than 0.0001%. In some embodiments, the compositions or articles described herein may be free or substantially free from any specific components not mentioned within this specification.

As used herein, “modified starch” refers to a class of low-molecular-weight carbohydrates that can be produced by the hydrolysis of starch. Modified starches can include mixtures of polymers of D-glucose units linked by α-(1→4) or α-(1♯6) glycosidic bonds. Modified starch materials as used herein may have a molecular weight of from 1,000 g/mol to 30,000 g/mol, significantly lower than natural starch materials.

As used herein, “starch” refers to a polymeric carbohydrate including numerous glucose units joined by glycosidic bonds, as produced by various plants for energy storage. Starch is contained in significant quantities in potatoes, corn, rice, wheat, and other plants. Starch typically includes both linear amylose and branched amylopectin, where the ratio of amylose to amylopectin depends on the plant source, etc. Molecular weight of starch materials is typically very high, e.g., 100,000 g/mol to tens of millions, or higher.

Molecular weight values as provided herein are weight average molecular weights, unless otherwise indicated.

Particle size ranges and distributions as described herein can be determined by typical screening methods known to those of skill in the art.

Bulk density is an important property of animal litter. Bulk density is a property of powders, granules and other “divided” solids. It is defined as the mass of the many particles of the material divided by the total volume they occupy. The total volume includes particle volume, inter-particle void volume and internal pore volume. Bulk density is not necessarily an intrinsic property of a material; it can change depending on how the material is handled. For example, a powder poured into a container will have a particular bulk density; if the container is disturbed (e.g., vibrated), the powder particles will move and usually settle closer together, resulting in a higher bulk density. Bulk density is a measure of the weight of the litter per unit volume (g/cm³ or lb/ft³). One test method used to measure bulk density comprises a hopper with a container (e.g., volume of 1 pint) underneath. The hopper is filled with a given volume (e.g., approximately 2000 cm³) of the sample. The gate situated at the bottom of the hopper is opened to fill the container with material until it overflows. The container is then leveled out using a straight edge tool and the weight is recorded. The same process is repeated twice and an average of three reps is reported (g/cm³ or lb/ft³).

As used herein the term “PAC” means powdered activated carbon that is a fine black powder made from wood or other carbon-containing materials (e.g., coconut, coal, etc.) that have been exposed to very high temperatures in an oxygen free environment and treated, or activated, to increase its ability to absorb by reheating with oxidizing gas or other chemicals. The result is a highly porous fine powder with a particle size less than about 0.25 mm and typically ranging from about 50 to about 150 m.

As used herein the term “clump retention” means the weight percentage of particles retained in the clump (e.g., after three hours) using the clump retention test method described herein. Synthetic urine comprising a solution of urea, ammonium chloride, and sodium phosphate can be used to evaluate clump retention. The solution can be pH adjusted using 0.2M hydrochloric acid to a final range pH range of 6.5 to 6.53. Use of such a synthetic urine is designed to mimic the clump performance of actual cat urine. A calibrated programmable peristaltic pump can be used to deliver a desired volume of the synthetic urine onto a bed of test litter. For example, synthetic urine can be dosed onto the litter in 10 mL increments. For the clump retention measurements, six clumps were produced for each measurement. Three clumps were small and contain 10 mL of synthetic urine. Three clumps were large and contain 20 mL of synthetic urine. One hour after initial dosing, the peristaltic pump was used to re-dose half of the clumps, to produce the larger clumps. All clumps were allowed to cure for a total time of 3 hours (i.e., the small clumps had 3 hours since their only dosing, while the large clumps had 3 hours from their initial dose, and 2 hours from their final dose). After curing, all clumps were gently scooped from the box and placed on a ½″ sieve. The clumps were shaken using a Ro-Tap with the hammer disengaged. The mass of the clumps was recorded before and after agitation on the Ro-Tap. Clump retention was calculated as final weight divided by initial weight and reported in percent.

As used herein the term “clump strength” means the strength of the clump after a given period of time (e.g., 10 min, 30 min, 1 hour, 3 hours, etc.) using the clump strength test method described herein. A TA·HDplusC Texture Analyzer was used to measure the clump strength of each clump. First, a solution of synthetic urine was prepared as described above. 10 mL of synthetic urine was dosed onto a bed of litter using a calibrated programmable peristaltic pump. Clumps were allowed to cure for the noted time (e.g., 10 min, 30 min, 1 hour, 3 hours, etc.). Each clump was removed from the bed of litter and placed on the stage of the Texture Analyzer. A TA-42 knife blade probe with 45° chisel end was affixed to the machine. Clumps were positioned upside down with the longest diameter in the x-y plane aligned to the probe. The probe was lowered until just touching the clump. The program was set such that the probe descends to 3 mm from the stage. Force measurements throughout this height range are recorded in grams-force (g_{f}). A peak force measurement was extracted graphically from the resulting force-height plot. Typically, three replicates are averaged together to produce one clump strength measurement.

Some exemplary white, substantially neutral pH litter substrates as contemplated herein are formed from composite particles. Methods for creating the composites disclosed herein include, without limitation, a pan agglomeration process, a high shear agglomeration process, a low shear agglomeration process, a high pressure agglomeration process, a low pressure agglomeration process, a rotary drum agglomeration process, a mix muller process, a roll press compaction process, a pin mixer process, a batch tumble blending mixer process, an extrusion process or a fluid bed process. Any of such may be used to provide “agglomeration” as described herein. The agglomeration process in combination with the materials used allows the manufacturer to control the physical properties of particles, such as bulk density, dust, strength, as well as particle size distribution (PSD) without changing the fundamental composition and properties of the component particles.

A high shear or low shear agglomeration process may be used for agglomeration. Such high shear and low shear agglomeration processes refer to high speed, conditioning and micro-pelletizing processes that convert powder (e.g., starch and lower molecular weight modified starch powders) into small agglomerates through the addition of water (e.g., and high speed) to cause the powder components to agglomerate together to form composite particles. As used herein the term “component” when used in conjunction with a composite particle means a small particle of one material that was combined with other small particles of itself and/or of small particles of different materials to form a composite particle. Such processes may use a pin mixer, a pan agglomeration process, a rotary coating process, a rotary drum agglomeration process, a mix muller process, a roll press compaction process, a batch tumble blending mixer process, or the like to form discrete composite particles.

In an embodiment, the process and resulting composite particle substrate that provides clumping and is used as a “canvas” against which the color changing pH health indicator particles are observed is differentiated from the composites described in US2014/0069344, e.g., which uses a high temperature and high pressure extrusion process, and which describes in-situ formation of dextrin due to the extrusion conditions, rather than addition of relatively high fractions of an actual dextrin powder, which is homogenously distributed throughout the composite particle (e.g., rather than concentrated at an exterior surface or elsewhere within only a portion of such particle). Such extrusion may likely result in a product that is of relatively higher density, which may be “glassy” and/or crystalline, and which requires a subsequent milling step to provide the desired litter characteristics. Such extrusion processes are significantly more energy intensive than the agglomeration processes employed in preparation of the present examples. That said, where such a process can produce a white, substantially neutral pH particulate litter substrate, such can be used in the present invention. For example, such a litter substrate can be mixed with pH health indicator particles, to provide a “canvas” backdrop against which any color change exhibited by the pH health indicator particles may be observed. It is particularly advantageous where the litter substrate (no matter how formed, or how configured) provides good clumping characteristics, while also being white, and having a substantially neutral pH.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

### II. Introduction

The present invention relates to litter products that provide clumping, while at the same time, provide a pH health indicator, to let a pet owner know whether their pet's urine pH is normal, or abnormal. While pH health indicating litters are available, they are not clumping. Furthermore, providing a clumping litter with a pH health indicator benefit is not as simple as adding pH health indicator particles to a sodium bentonite clumping litter, as such a sodium bentonite clumping litter has a significantly basic pH (e.g., 8 to 9), which interferes with the ability to obtain an accurate reading from the pH health indicator particles. In addition, in order to obtain an accurate and easy reading from the pH health indicator particles, it is necessary that the background “canvas” provided by the litter substrate be white, rather than some other color. Such is important to ensure that the color change provided by the pH health indicator particles is easily visible, and not masked by an interfering color of the litter substrate used with such pH health indicator particles. For example, clumping sodium bentonite clay litter particles are naturally dark gray and/or brown in color, making this material unsatisfactory for use.

An ideal litter substrate for use with such pH health indicator particles would be white in color, to provide the desired white canvas background against which the color change of the pH health indicator particles could be viewed, while also providing clumping characteristics, and while being substantially neutral in pH, so as to not interfere with, or mask accuracy of results shown by the pH health indicator particles.

The present invention provides litter products meeting these criteria (i.e., white, clumping, and substantially neutral pH).

In an embodiment, the litter substrate used with the pH health indicator particles is a composite particle litter substrate. In an embodiment, such composite particle litter substrate is formed from plant-based, non-mineral, renewable materials. More specifically, in an embodiment, the composite particles are formed from starch (e.g., high molecular weight natural starch) and a lower molecular weight modified starch (e.g., dextrin). Other adjuncts, such as powdered activated carbon, preservatives, etc. may be included. While largely described in the context of such composite particles formed from starch and a modified starch, it will be appreciated that other litter substrates that provide for clumping, while also being white, and having a substantially neutral pH may be used. Possible example materials may include kaolinite with limestone, and/or titanium dioxide (TiO₂). For example, it may be possible to agglomerate such materials together, e.g., perhaps with a material that may provide clumping characteristics, e.g., a small or moderate amount of calcium bentonite clay treated with soda ash which is substantially white in color (as opposed to mined sodium bentonite which is dark gray to brown in color), to provide a viable litter substrate that would be white, provide clumping characteristics, while exhibiting a substantially neutral pH. Such alternatives that provide a litter substrate that would be white and clumping, while providing a substantially neutral pH are within the scope of the present invention.

In a particular embodiment, the present invention employs as the white “canvas” background composite absorbent particles that comprise powdered starch and powdered modified starch (such as dextrin). As described in U.S. Patent Publication No. 2022/0400648, Applicant has surprisingly found that by using a blend of both starch and low weight modified starch such as dextrin in the agglomeration components fed to the pin mixer or other high shear agglomeration process, that a clumping litter product providing high clump strength and clump retention can be formed. Such is surprising, given that previous attempts to provide a clumping litter product with clump retention and clump strength similar to that provided by sodium bentonite clay litter products has not been possible. For example, such a litter substrate provide a 100% plant-based clumping litter product that is white, has a substantially neutral pH, and provides clumping characteristics similar to, or even superior to sodium bentonite litter, which represents the current “gold standard” for clumping litter products.

Such litter substrates may advantageously provide absorbency values of at least 0.45 g of urine or other liquid per g of litter (i.e., g liquid/g litter). Such absorbency values may be similar to, or even superior to that provided by sodium bentonite litter. In addition to such excellent properties relating to whiteness, substantially neutral pH, clump retention, clump strength, low dust, and absorbency, the such litter substrates may exhibit bulk density values that are significantly lower than that associated with sodium bentonite litter products, which are relatively heavy. For example, sodium bentonite litter may have a bulk density of about 68 lb/ft³, while the presently described litter substrates (and resulting litter products, after addition of the pH health indicator particles) may have bulk density values of less than 60 lb/ft³, or less than 50 lb/ft³, such as from 30 to 50 lb/ft³. Such reduced density values improve the ease with which consumers can move, dispense, and clean up such litter products.

### III. Exemplary Litter Products and Their Components

### a. pH Health Indicator Particles

The contemplated litter products include a fraction of pH health indicator particles, e.g., admixed with the white, substantially neutral pH clumping litter substrate. Such pH health indicator particles may comprise silica gel, e.g., as described in U.S. Pat. No. 7,343,874, herein incorporated by reference in its entirety. Such health indicator particles (e.g., silica gel crystals) may further include a color changing pH indicator, providing color changes within the desired pH range. For example, the pH indicator may be of a first color (e.g., yellow) when wetted with a liquid having a substantially neutral pH (e.g., cat urine with a normal pH of about 6.5). The pH indicator may change to a second color (e.g., orange and/or red) when wetted with a liquid having a more acidic pH, e.g., such as less than 6, or less than 5. The pH indicator may change to a third color (e.g., green and/or blue) when wetted with a liquid having a more basic pH, e.g., such as greater than 7.5, or greater than 8.

Any of a wide variety of pH indicators may be suitable for use, including combinations of two or more different pH indicators. Examples include, but are not limited to thymol blue, pentamethoxy red, tropeolin OO, 2, 4-dinitrophenol, methyl yellow, methyl orange, bromophenol blue, tetrabromophenol blue, alizarin sodium sulfonate, α-naphthyl red, ρ-ethoxychrysoidine, bromocresol green, methyl red, bromocresol purple, chlorophenol red, bromophenol blue, ρ-nitrophenol, azolitmin, phenol red, neutral red, rosolic acid, cresol red, α-naphtholphthalein, tropeolin OOO, thymol blue, phenolphthalein, α-naphtholbenzein, thymolphthalein, nile blue, alizarin yellow, salicyl yellow, diazo violet, tropeolin O, nitramine, poirrier's blue, and trinitrobenzoic acid.

The pH health indicator particles are typically not clumping in and of themselves. As such, they are included in a minor amount within the present clumping litter compositions, e.g., in an amount of no more than 25%, no more than 20%, no more than 15%, or no more than about 10%, at least 1%, at least 2%, at least 3%, at least 5%, such as from 1-25%, or 5-15% (e.g., about 10%) by weight.

b. White, Clumping, Substantially Neutral pH Litter Substrate

The present litter compositions include a white, substantially neutral pH litter substrate that exhibits clumping characteristics. While mineral based substrates providing such characteristics could conceivably be used (e.g., kaolinite with limestone and/or titanium dioxide), perhaps agglomerated together with a minor amount of clumping bentonite clay powder, in an embodiment, the employed white substantially neutral pH litter substrate that exhibits clumping is provided by composite particles formed from plant-based non-mineral components, such as starch powder and a low molecular weight modified starch powder.

No matter what formed from, a composite particle is a discrete particle formed by the agglomeration of smaller component particles. By way of example, components that may be included in such composite particles include, but are not limited to, powdered starch, powdered modified starch, and PAC. In an embodiment, the composite particles and the litter as a whole may advantageously be free or substantially free from inorganic mineral-based litter components which are not renewable, such as sodium bentonite, calcium bentonite, kaolinite, or other clay materials, limestone, dolomite, calcite, calcium carbonates, sand, shale, gravel, titanium dioxide and slate. In addition, in an embodiment the present composite particles may be free from large sized cellulose materials (e.g., wood chips) such as described in U.S. Pat. No. 9,010,274. Indeed, in some embodiments, the composite particles themselves may be free of even powdered small particle cellulose materials (e.g., wood powder). While starch and cellulose are similarly formed from glucose units, it will be appreciated that starch often includes some degree of branching, while cellulose is linear, and cellulose joins the glucose units with beta glucose unit linkages while starch exhibits alpha glucose unit linkages.

While such materials (e.g., cellulose or inorganic mineral-based components) may not be present within the composite particles themselves, it will be appreciated that the litter product comprising the composite particles may optionally be dry mixed (e.g., a “salt-pepper” blend) with any of a wide variety of materials, including those mentioned above. For example, in an embodiment, the composite particles as described herein may be dry mixed with wood particles (e.g., sawdust or wood chips) or other agricultural product particles (e.g., pulp, corn cob, bran, grits, almond or walnut hulls, almond or walnut shells, or any of a variety of other grains) to further reduce bulk density. In an embodiment, the composite particles and/or the litter product as a whole is void or substantially void of inorganic mineral-based litter components. For example, the composite particles may be entirely free or substantially free of components that are not renewable plant-based materials. In an embodiment, the litter product may consist of, or consist essentially of the composite particles and the pH health indicator particles.

Composite particles can be formed using a high shear or other agglomeration process including, but not limited to, a pin mixer or the like where the agglomeration process is used to form the discrete composite particles. A pin mixer is a pin-type, high speed, conditioning and micro-pelletizing device that converts small particles (i.e., powders) into larger, discrete agglomerates (“composite particles”) through the action of high speed and the addition of a binder, which can be a simple binder such as water. Other agglomeration processes include but are not limited to pan agglomerators, disc pelletizers, drum granulators or pugmills.

Such agglomeration processes and the composite particles they produce are described in Applicant's U.S. Pat. Nos. 9,283,540 and 10,383,308, each of which is herein incorporated by reference in its entirety. Such processes differ from extrusion type processes, e.g., as described in US 2014/0069344, in that such pin mixers and other agglomerators apply high or low shear and use of water as a binder, to cause the small powder component particles of starch and dextrin to agglomerate together, e.g., forming a composite particle that may be substantially homogenous in that the various powder particle components of starch and modified starch (or other components fed into the process) are substantially homogeneously distributed throughout the resulting composite particle. Extrusion processes are different in that they operate under elevated temperature and pressure conditions, to mix (and often chemically react) the various components present within the extrusion system. In addition, the extrusion process described in US 2014/0069344 does not actually result in a litter capable of clumping by itself, but requires application of a sodium bentonite clay coating over the extruded pellets, in order to cause the pellets to be capable of clumping.

The presently described process for producing composite particles is advantageously simple, and does not require elevated temperature or pressure conditions, but simply acts to mix the powder components (e.g., starch, modified starch, and optionally PAC) with water under high shear conditions to cause the small powder particles to agglomerate together, to form larger composite particles. When using fractions of starch and modified starch as described herein, composite particles can be formed that are capable of serving as a clumping, substantially neutral pH litter product, and that are white in color, to provide a good “canvas” against which the color changing pH health indicator particles can be easily and quickly evaluated.

All components (e.g., starch, modified starch, and PAC) used in forming the composite particles typically are of initially very small particle sizes, so as to be accurately described as powders. They are smaller than “granular” materials that may optionally be dry blended with the composite particles, or granular materials that are used in dry mixed litter products. Particles this small can contribute to dusting problems, if not agglomerated into composite particles.

The composite particles contain (relative to each other) approximately the same level of the various components used to form such particles. Furthermore, in an embodiment, such composite particles typically do not include a core and shell structure, but a relatively homogenous distribution of the powder components from which the composite particle is formed, where each composite particle includes each component used in forming the composite particles. That said, core and shell structures are possible, as described herein, for example, a core of an absorbent (e.g., renewable) material such as one or more of wood, corn cob, corn, bran, grits, almond or walnut hulls, almond or walnut shells, straw, a grain, or another agricultural product particle, with the starch and modified starch mixture agglomerated together over the core, so that the starch and modified starch agglomerated composite forms a shell over such a core.

The composite particles are larger than their constituent components and may have particle sizes ranging from about 300 μm (0.3 mm) to about 3350 μm (3.35 mm) (i.e., 6/50 mesh) or from about 300 μm (0.3 mm) to about 1700 μm (1.7 mm) (i.e., 12/50 mesh), or from about 300 μm (0.3 mm) to about 1180 μm (1.18 mm) (16/50 mesh). Applicant's U.S. Publication No. 2021/0169037, which application is herein incorporated by reference in its entirety, describes how benefits of improved dusting, clump geometry, and more efficient clumping are obtainable when a particle size distribution of 16/50 mesh is selected for a litter product.

i. Powdered Starch

In an embodiment, the composite particles include a powdered starch component. The powdered starch has small particle sizes as described herein, for example no larger than 200 mesh (75 μm), no larger than 280 mesh (44 μm), no larger than 320 mesh (36 μm) or no larger than 400 mesh (23 μm). By way of example, the powdered starch may have particle sizes similar or smaller to that of any PAC incorporated into the composite particles (e.g., from 50-150 μm). Such sizes are significantly smaller than the resulting composite particles within which the starch component is integrated. Inclusion of the powdered starch in the fractions described herein aids in providing an absorbent litter product capable of good absorption and strong clumping, similar or superior to the clumping characteristics of a sodium bentonite litter product. Such starch is also white in color, and substantially neutral in pH. By way of example, the starch may be present in the composite particles in an amount of at least 50% by weight, such as up to 90% by weight. In an embodiment, the starch may be present in an amount of at least 55%, 60%, 70%, 75%, 80% or 85% by weight. The starch may be present in an amount of no more than 85%, 80%, 75%, 70%, 65%, 60%, or 55% by weight. Exemplary ranges include, but are not limited to 50% to 90%, 55% to 85%, 60% to 80%, or 65% to 75% by weight of the composite particles. Such fractions are on a dry basis (e.g., not including any residual water that may be present within the finished composite particles).

A variety of starch materials can be used, e.g., including but not limited to starches sourced from corn, potato, pea, wheat and the like.

ii. Powdered Lower Weight Modified Starch

The composite particles include powdered dextrin or a similar modified starch in addition to powdered starch. While composite particles formed entirely from starch, or entirely from modified starch do not result in a clumping litter product, use of powdered starch and powdered modified starch in concentrations as described herein advantageously and surprisingly provide a litter product exhibiting excellent clumping and absorption characteristics, as well as low dusting characteristics. Like the starch component, the powdered dextrin or other modified starch has small particle sizes as described herein, for example no larger than 200 mesh (75 μm), no larger than 280 mesh (44 μm), no larger than 320 mesh (36 μm) or no larger than 400 mesh (23 μm). By way of example, the powdered modified starch may have particle sizes similar or smaller to that of any PAC incorporated into the composite particles (e.g., from 50-150 m). Inclusion of the powdered modified starch in the fractions described herein allows the resulting composite particle litter product to exhibit strong clumping, similar or superior to the clumping characteristics of a sodium bentonite litter product. By way of example, the dextrin or other modified starch may be present in the composite particles in an amount of more than 10% by weight, such as up to 50% by weight. In an embodiment, the starch may be present in an amount of at least 12%, 15%, 16%, 18%, 20%, 25%, 30%, 35%, 40%, or 45% by weight. The dextrin or other modified starch may be present in an amount of no more than 50%, 45%, 40%, 35%, 30%, 25%, or 20% by weight. Exemplary ranges include, but are not limited to 10% to 50%, 15% to 45%, 15% to 40%, or 20% to 40% by weight of the composite particles. Such fractions are on a dry basis (e.g., not including any residual water that may be present within the finished composite particles). The composite particles may consist essentially of starch and modified starch, with PAC optionally being present. Minor additives (e.g., preservatives, fragrances, colorants, dyes or pigments) and the like may be added.

The modified starch component may have a relatively low molecular weight, significantly lower than that of the starch component. For example, the molecular weight of the modified starch component may be less than 50,000 g/mol, less than 40,000 g/mol, less than 30,000 g/mol, at least 500 g/mol, at least 1,000 g/mol, such as from 1,000 g/mol to 30,000 g/mol. The molecular weight of the starch may typically be far higher, e.g., greater than 100,000 g/mol, or greater than 1 million g/mol, such as several tens of millions g/mol.

A variety of modified starch materials can be used, e.g., including but not limited to dextrins or other modified starches derived from corn, potato, pea, wheat and the like. In an embodiment, the modified starch may be sourced from a different plant as compared to the starch (e.g., corn starch and wheat modified starch).

iii. Powdered Activated Carbon (PAC)

The composite particles can include a powdered activated carbon (PAC) component. Powdered activated carbon is a fine black powder made from wood or other organic carbon-containing materials (e.g., coconut, coal, etc.) that have been exposed to high temperatures in a reduced or oxygen free environment and treated, or activated, to increase the material's surface area by heating in the presence of an oxidizing gas or other chemicals. The result is a highly porous fine powder with small particle sizes (e.g., from about 40 μm to about 150 μm), which material is capable of absorbing odor causing volatile compounds.

The inclusion of PAC or a similar odor control agent in the composite particle increases the odor control properties of the present litter compositions. Inclusion of the PAC within the composite particle provides excellent odor control properties, without inclusion of separate and discrete very small carbon particles dry blended in the litter composition. In an embodiment, the PAC can be included in the composite particles or the litter product as a whole in an amount of from 0.1% to 5%, from 0.25% to 3%, or from 0.5% to 1% by weight. Where PAC is included in the litter product, it is not necessary that the PAC be included in each composite particle. For example, in an embodiment, the litter product may include composite particles that include PAC, along with composite particles that do not include PAC. For example, two different types of composite particles can be prepared, and then dry blended together (e.g., one type with PAC, and one type without). By way of example, where two types of composite particles are dry mixed together, e.g., at a 1:1 ratio, the composite particles including the PAC may include PAC at double the concentration that the PAC is included relative to the litter product as a whole (e.g., 1% vs. 0.5%, or 2% vs. 1%).

iv. Pre-Gelatinized Starch or other High Viscosity Builder

The majority of the included starch is not gelatinized. That said, in an embodiment, a small portion of the starch may be pre-gelatinized. By way of example, such a pre-gelatinized starch may be included in an amount of less than 10% or less than 5%, such as 1% to 4% by weight of the composite particles. Inclusion of such a component may serve to increase viscosity, and improve the regularity or uniformity of the clump shapes formed upon wetting of the litter during use. Such a component may also serve to decrease brittleness of the resulting clumps. Other high viscosity builders may be suitable for use as an alternative, or in addition to use of pre-gelatinized starch. A non-limiting example of such is guar gum, or other gum materials. Although inclusion of such a pre-gelatinized starch may decrease initial clump strength to some extent, initial clump strength is still acceptable, and quickly increases to a value of 1,000 g_{f} or higher.

c. Clumping Characteristics

By way of example, whether the litter substrate is comprised of composite particles as described, or some other litter substrate that is white, and substantially neutral, the litter product may exhibit a clump retention of at least 90%, at least 91%, at least 92%, at least 93%, at least 94%, at least 95%, at least 96%, at least 97%, or at least 98%. Such values are very high, e.g., as high, or higher than clump retention values provided by sodium bentonite clumping litter products. In addition, such litter substrate is white (while sodium bentonite is not), and provides substantially neutral pH (while sodium bentonite does not).

In an embodiment, clump strength (even initial clump strength at 1 minute, or 10 minutes after wetting) may be at least 1,000 g_{f} and/or similar or better than that provided by a sodium bentonite clay litter product. By way of comparison, a sodium bentonite clumping litter product may provide an initial clump strength of less than 1,000 g_{f} (e.g., about 750-800 g_{f}), and may take 2-3 hours after initial dosing to reach a clump strength of 1,000 g_{f}. The present litter products may provide a clump strength of at least 1,000 g_{f}, at least 1,200 g_{f}, at least 1,500 g_{f} or at least 2,000 g_{f}, such as from 1,000 g_{f} to 10,000 g_{f}, or from 1,000 g_{f} to 8,000 g_{f}. Such values may be for initial clump strength (e.g., immediately after wetting, at 1 minute, or at 10 minutes), or after a given cure time (e.g., 30 minutes, 1 hour, 2 hours, 3 hours, etc.). The clump strength of the present litter compositions is advantageously relatively high shortly after wetting (e.g., even within 10 minutes), and becomes even stronger after a short period of time (e.g., 2-3 hours). As a result, when a user cleans out a litter box (e.g., once a day or other frequency), the clumps that have formed will exhibit high clump strength and clump retention values, to as to remain intact, rather than crumbling or otherwise breaking apart, or being “mushy”, both of which are undesirable.

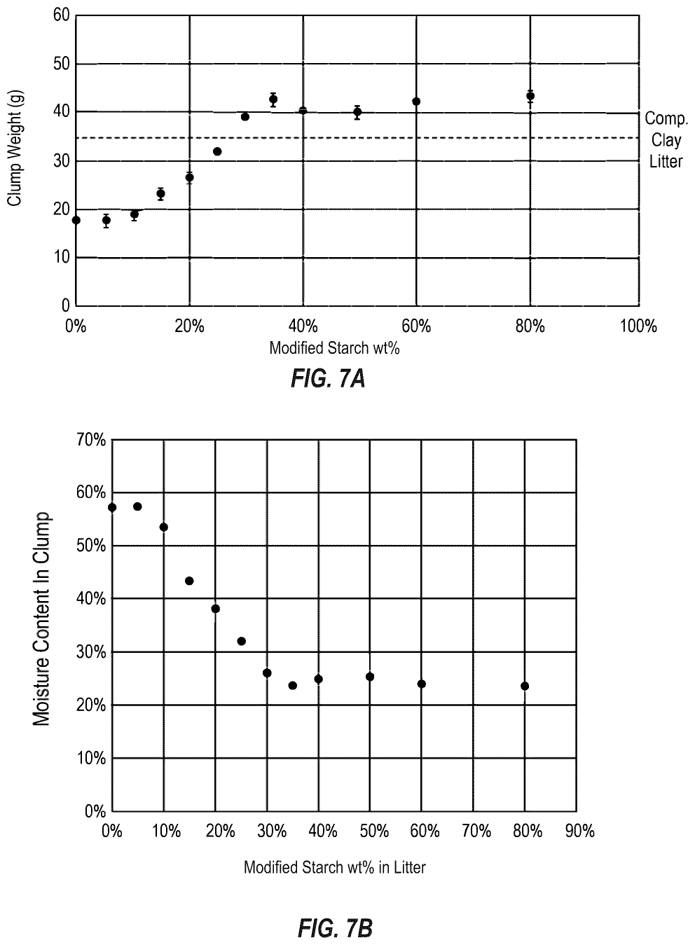

By way of example, the litter product may exhibit a clump weight of no more than about 50 g, no more than 40 g, or no more than about 30 g, (e.g., 15 to 40 g may be typical) when dosed with 10 g (or 10 mL) of water or urine. Such clump weights (e.g., and those reported in FIG. 7A and elsewhere herein) may include the weight of the dosing liquid.

The present litter product may exhibit an absorbency that is equal to or greater than a sodium bentonite litter product. By way of example, the litter may have an absorbency of at least 0.45 g liquid/g litter, at least 0.50 g liquid/g litter, or from 0.45 to 1 g liquid/g litter. Such increased absorbency results in a more efficient use of the litter product, as less litter product is required to absorb a given volume or mass of liquid.

Bulk density of starch/modified starch composite particle litter substrates as described herein is advantageously relatively low, by comparison to existing sodium or calcium bentonite clay litter products, which are heavy. For example, sodium bentonite litter has a bulk density of about 68 lb/ft³. Calcium bentonite litter is similarly high in density. The composite litter substrates formed from starch and modified starch as described may have a bulk density of less than 60 lb/ft³, less than 50 lb/ft³, such as from 30 to 50 lb/ft³.

d. Low Dusting Characteristics

In an embodiment, the litter composition may be free or substantially free of fine particles that would pass through a size 100 mesh (e.g., 0.150 mm or 150 μm sieve opening). For example, as manufactured, or after shipping to a retailer or consumer, the composition may not include more than about 10%, more than about 5%, more than about 4%, more than about 3%, more than about 2.5%, more than about 2%, more than about 1.5%, or more than about 1% of such fines. The presence of such fines can lead to increased dust. For example, such fines contribute to dust generation when pouring such a litter product. While some amount of fines smaller than the lower end cut-off (e.g., 40 mesh, 50 mesh or other value) may eventually form due to attrition of larger particles, the present litter products have been found to provide for excellent low dusting characteristics, whether a de-dusting agent, such as PTFE, lignosulfonate or mineral oil is included or not.

By way of example, the litter product may generate no more than about 20 mg, no more than about 15 mg, no more than about 10 mg, or no more than about 5 mg of dust in a gravimetric dust measurement, with an 850 cm³ litter sample. The gravimetric dust measurement test measures the tendency of a litter product to generate dust during a consistent pouring from a specific height and duration. Two 850 cc samples of each litter substrate to be tested were weighed out. Whatman Qualitative Grade 4 Filter paper of a standardized size (e.g., 9″×4″) was provided, and its initial weight recorded. The gravimetric dust measurement unit includes an enclosure which is fitted with a drop funnel and slide gate assembly used to drop the litter into a vessel in the enclosure. An external fan is used to pull air from the enclosure through the filter paper holder assembly, trapping the dust in the filter paper. The filter paper was placed into the sample holder on the gravimetric dust measurement unit, and the litter product to be tested was poured into the cone at the top of the gravimetric dust measurement unit. The vacuum fan of the gravimetric dust unit was activated, and after 5 seconds, the slide gate under the cone was opened, allowing the litter in the cone to fall. The vacuum was allowed to run for 30 seconds after the lever was opened (35 seconds total). After shutting off the vacuum fan, the sample holder was opened, and the filter paper removed. The filter paper including dust captured therein was reweighed. The difference between the initial weight and the final weight (in mg) is the amount of dust generated for the 850 cm³ sample.

Mesh sizes and particle sizes will be familiar to those of skill in the art. Various mesh size characteristics are shown below in Table 1.

TABLE 1

| Sieve Size (mm) | Opening (μm) | U.S. Standard Mesh Size |
|---|---|---|
| 5.60 | 5600 | 3.5 |
| 4.75 | 4750 | 4 |
| 4.00 | 4000 | 5 |
| 3.35 | 3350 | 6 |
| 2.80 | 2800 | 7 |
| 2.36 | 2360 | 8 |
| 2.00 | 2000 | 10 |
| 1.70 | 1700 | 12 |
| 1.40 | 1400 | 14 |
| 1.18 | 1180 | 16 |
| 1.00 | 1000 | 18 |
| 0.85 | 850 | 20 |
| 0.71 | 710 | 25 |
| 0.60 | 600 | 30 |
| 0.50 | 500 | 35 |
| 0.425 | 425 | 40 |
| 0.355 | 355 | 45 |
| 0.300 | 300 | 50 |
| 0.25 | 250 | 60 |
| 0.212 | 212 | 70 |
| 0.180 | 180 | 80 |
| 0.15 | 150 | 100 |
| 0.125 | 125 | 120 |
| 0.105 | 105 | 140 |
| 0.090 | 90 | 170 |
| 0.075 | 75 | 200 |

The present litter products may employ any desired particle size cutoffs, e.g., such as, but not limited to 6/50, 12/50, 16/50, 8/40 or 12/40 wherein particles sized larger the first number and fines sized smaller than the second number are rejected. For example, cutoffs of 6/50 correspond to a litter that will pass through a 6 mesh screen but be retained on a 50 mesh screen.

### IV. Examples and Experimental Results

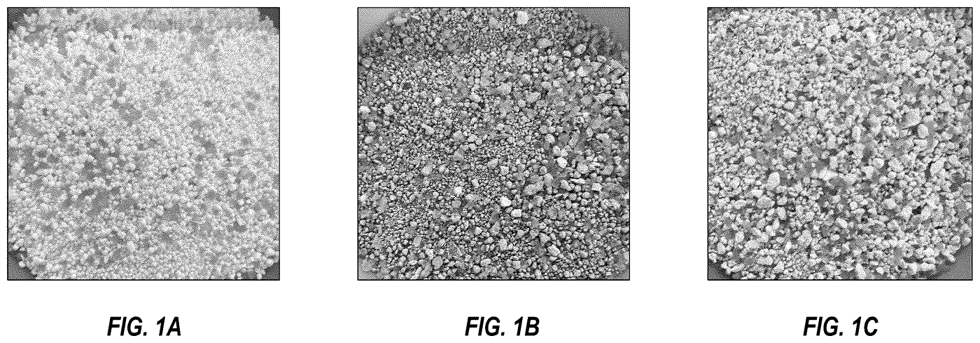

FIGS. 1A-1C illustrate exemplary and comparative litter products. FIG. 1A shows a litter composition according to the present invention, that includes a white, substantially neutral pH litter substrate. The particular litter substrate shown in FIG. 1A is formed from composite particles of starch and modified starch, as described. The litter product includes 90% by weight of such white composite particles, with 10% by weight of pH health indicator particles, dry mixed with the white litter substrate particles. The pH health indicator particles are initially yellow in color.

FIG. 1B shows a comparative litter product, which includes the same 10% pH health indicator particles, which are yellow in color, dry mixed with a conventional sodium bentonite litter substrate. While the sodium bentonite litter substrate provides good clumping characteristics, it is not white in color, but is noticeably off white, having a dark gray or brown color. In addition, the sodium bentonite litter substrate is not substantially neutral in pH, but has a pH that is considerably basic, having a pH of about 8-9.

FIG. 1C shows another comparative litter product, which includes the same 10% pH health indicator particles, which are yellow in color, dry mixed with a conventional calcium bentonite litter substrate, which has been treated with soda ash. While the treated calcium bentonite litter substrate provides fairly good clumping characteristics, and is nearly white in color (it is white to light gray), it is not substantially neutral in pH, but has a pH that is considerably basic, having a pH of about 8-9.

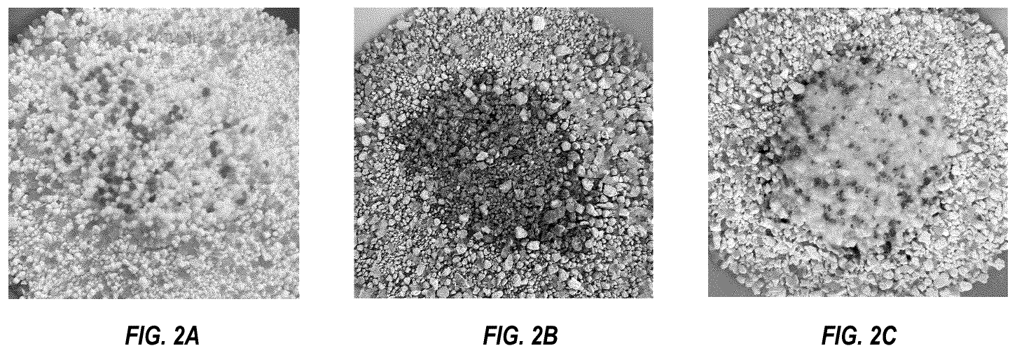

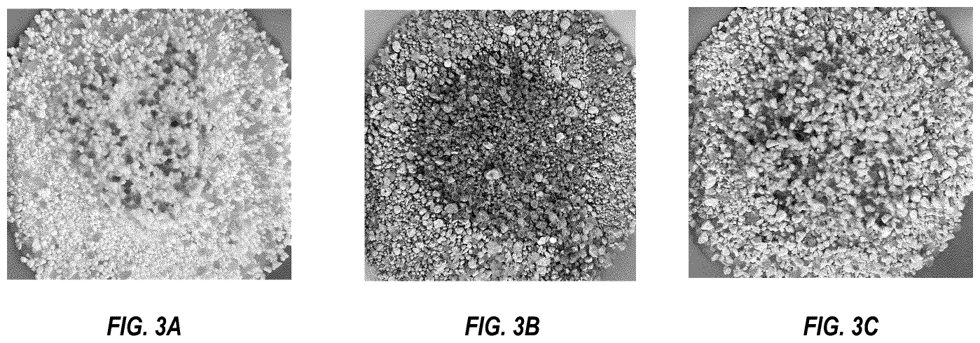

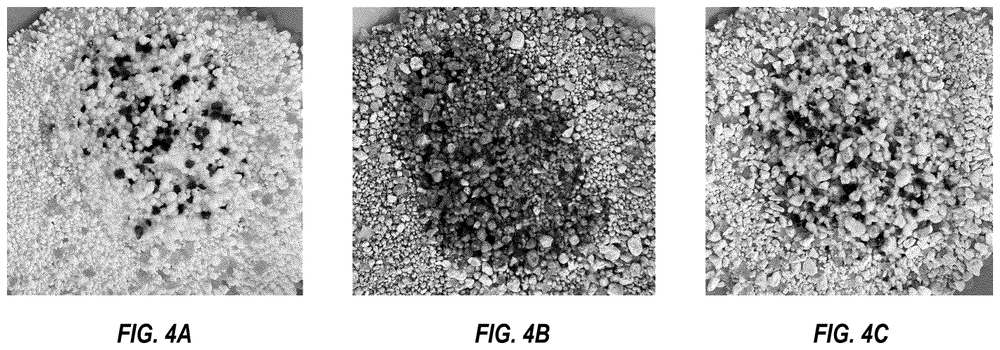

FIGS. 2A-4C show how such litter products perform, when dosed with a liquid composition, such as an abnormally acidic pH cat urine having a pH of 4.5 (FIGS. 2A-2C), a normal pH cat urine having a pH of about 6.5 (FIGS. 3A-3C), or an abnormally basic cat urine having a pH of 9 (FIGS. 4A-4C).

Referring to FIG. 2A, the litter of FIG. 1A, when dosed with a pH 4.5 solution, shows a color change for the contacted color changing pH health indicator particles, from yellow to a clear orange. This change in color is readily apparent, against the white background of the composite particles litter substrate. The image also shows how adjacent pH health indicator particles, which were not dosed, remain their initial yellow color.

FIG. 2B shows the litter of FIG. 1B when dosed with the same pH 4.5 solution. It is important to recall that the litter substrate in FIG. 2B (sodium bentonite clay) is basic in pH, while the dosing liquid is acidic. There is some neutralization of the dosing liquid that occurs, making it more difficult to identify whether the pH health indicator particles are indicating that the dosing liquid is of an abnormally acidic pH, or not. The illustrated pH health indicator particles that were wetted show less visible orange or yellow orange color, against a dark substrate.

FIG. 2C shows the litter of FIG. 1C when dosed with the same pH 4.5 solution. It is important to recall that the litter substrate in FIG. 2C (calcium bentonite clay treated with soda ash) is basic in pH, while the dosing liquid is acidic. There is some neutralization of the dosing liquid that occurs, making it more difficult to identify whether the pH health indicator particles are indicating that the dosing liquid is of an abnormally acidic pH, or not. In addition, there is confusion caused, because some of the liquid actually results in a change of the pH health indicator to a color indicative of an abnormally basic cat urine, in that particularly around the periphery of the dosed area, some of the pH health indicator particles have changed to blue or green in color. Even though the litter substrate is near white, the pH of the litter substrate interferes with the ability to achieve accurate results, when attempting to “read” the color change of the pH health indicator particles.

Referring to FIG. 3A, the litter of FIG. 1A, when dosed with a neutral pH solution, shows a slight color change for the contacted color changing pH health indicator particles, from dry yellow to a clear yellow/orange color.

FIG. 3B shows the litter of FIG. 1B when dosed with the same neutral pH solution. While the color change exhibited by the wetted particles is similar to that exhibited in FIG. 3A, it is difficult to “read” the pH color changing particles, because of the dark non-white background provided by the sodium bentonite litter substrate.

FIG. 3C shows the litter of FIG. 1C when dosed with the same neutral pH solution. Here there is a mix of color changes, where some pH color changing particles have changed to blue or green, and others have changed to the clear orange color. Such a mix of colors causes confusion, as the blue and green colors are indicative of a cat urine having abnormally basic pH.

Referring to FIG. 4A, the litter of FIG. 1A, when dosed with a pH 9 solution, shows a color change for the contacted color changing pH health indicator particles, from yellow to a dark green to dark blue. This change in color is readily apparent, against the white background of the composite particles litter substrate. The image also shows how adjacent pH health indicator particles, which were not dosed, remain their initial yellow color.

FIG. 4B shows the litter of FIG. 1B when dosed with the same pH 9 solution. The illustrated pH health indicator particles that were wetted show green or blue color, which is less visible in contrast than that of FIG. 4A, because of interference by the dark substrate background provided by the sodium bentonite.

FIG. 4C shows the litter of FIG. 1C when dosed with the same pH 9 solution. Even though the litter substrate is near white, and the color change from yellow to blue and green is readily apparent, the problems associated with accuracy when dosing with neutral or acidic solutions make the calcium bentonite substrate of FIG. 4C less than ideal. It can be used to identify an abnormally high pH cat urine, but can give false positive results, when testing normal pH or abnormally acidic pH cat urine samples.

Such examples illustrate the importance that the litter substrate be both white in color, and substantially neutral in pH.

A variety of methods may be used to quantify whether a given substrate is sufficiently white, e.g., using colorimetry as described in U.S. Pat. No. 10,071,363, herein incorporated by reference in its entirety. Such colorimetry testing will be familiar to those of skill in the art. For example, colorimetric measurements can be provided on a scale of 0-100 where 0 is the most black (e.g., relative to a standard black reference) and 100 is the most white (e.g., relative to a standard white reference). The results can be reported as a percentage of black and percentage of white which together equal 100%. The human eye can only detect color shifts of about 3% or more so a 5-10% color shift only has a slight appearance of being darker. By way of comparison, a zeolite litter material (which is not clumping) may be “white” in color, providing a percentage white value when tested using colorimetry of 75% white (and 25% black). In an embodiment, the white litter substrate such as the starch/modified starch composite particles may provide a colorimetry white value of at least 75, at least 80, at least 85, or at least 90.

The following figures and test data characterize clump strength and clump retention, as well as various other aspects of exemplary white, substantially pH neutral composite litter substrates that may be used within the present litter products.

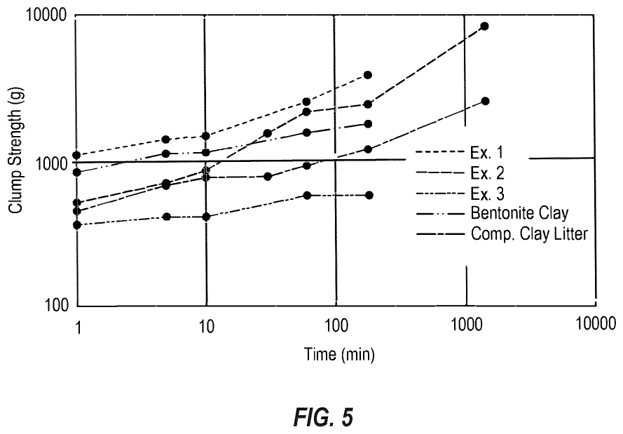

FIG. 5 shows clump strength for two exemplary white substantially neutral pH litter substrates (Examples 1 and 2) that may be used in the present invention, as well as various litter substrates (Example 3, sodium bentonite clay, and a comparative commercial clay litter comprising limestone and bentonite clay. The litter substrate of Example 1 was in the form of composite particles formed from 80% dent corn starch and 20% wheat modified starch (e.g., dextrin). The litter product of Example 2 was also in the form of composite particles, formed from 80% dent corn starch, 2.5% pre-gelatinized dent corn starch, and 17.5% wheat modified starch (e.g., dextrin). The litter product of Example 3 was also in the form of composite particles, formed from 80% dent corn starch and 20% pre-gelatinized dent corn starch. The comparative sodium bentonite clay litter product is 100% sodium bentonite granular clay (not composite particles). The comparative commercial clay litter comprising limestone and bentonite clay is a composite particle litter product formed from 70% sodium bentonite clay and 30% limestone.

As shown in FIG. 5, both Examples 1 and 2 provide good clump strength, even initially, where clump strength increases quickly, which is unusual for a plant-based non-mineral litter product. As shown in FIG. 5, the clump strength of Example 1 exceeds that of the sodium bentonite clay and the comparative commercial clay litter comprising limestone and bentonite clay at all times. Example 2 initially has a clump strength that is less than the comparative sodium bentonite clay, but the clump strength of this litter builds quickly, surpassing the clump strength of sodium bentonite clay within 30 minutes. The clump strength of Example 2 is slightly greater than that of the comparative commercial clay litter comprising limestone and bentonite clay product at 1 min, 5 min, and 10 min, after which the clump strength of Example 2 increases significantly faster than that of the comparative commercial clay litter comprising limestone and bentonite clay.

While the inclusion of a small fraction of pre-gelatinized starch in Example 2 slightly reduces initial clump strength, it was noted that it also improved the regularity and uniformity of the geometry of the resulting clump, and as noted, clump strength increases quickly so that by the time a typical user will remove clumps from the litter box, the clumps will be stronger than clumps of the sodium bentonite clay litter product. Like Example 1, Example 2 shows higher clump strength at all times, as compared to the comparative commercial clay litter comprising limestone and bentonite clay litter product. The measurements seen in FIG. 5 were taken at 1 min, 5 min, 10 min, 30 min, 60 min, 180 min, and 1440 min after dosing the respective litter product with 10 mL of synthetic urine, using the procedures as described herein.

As shown, the strength of Example 1 was at all points greater than 1,000 g_{f}, while the strength of Example 2 was nearly 1,000 g_{f} after 10 minutes, and far exceeded 1,000 g_{f} after 30 minutes. Example 3 is included to show the importance of inclusion of the modified component, as Example 3 included composite particles formed from 80% corn starch and 20% pre-gelatinized corn starch, with no lower molecular weight modified starch. As shown in FIG. 5, the clump strength of Example 3 is significantly lower than Examples 1 and 2, and never reaches 1,000 g_{f}, or exceeds that of the sodium bentonite clay or comparative commercial clay litter comprising limestone and bentonite clay comparative litter products.

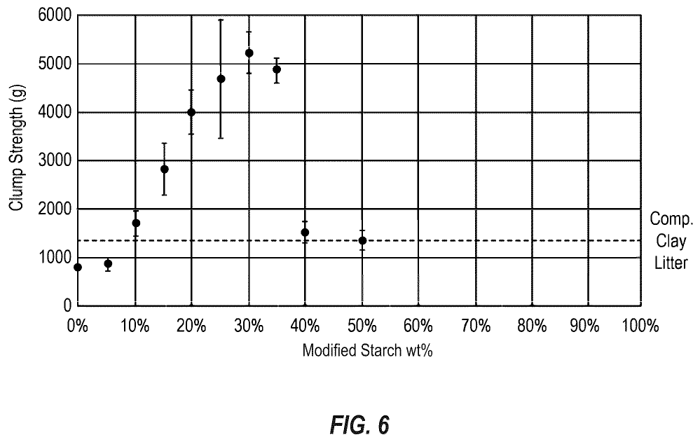

FIG. 6 shows clump strength for exemplary litter products at varying modified levels, from 5% up to 50% modified starch, 3 hours after dosing with 10 mL of synthetic urine. The clump strength values seen in FIG. 6 are for a formulation similar to that of Example 1, where the composite particles include starch and a lower molecular weight modified starch such as dextrin, without the inclusion of any pre-gelatinized starch. The horizontal dashed line indicates the clump strength for the comparative commercial clay litter comprising limestone and bentonite clay, which is at about 1,300 g_{f}. As shown in FIG. 6, the starch and modified starch composite particle litter product exhibits clump strength that is equal to or superior to the comparative commercial clay litter comprising limestone and bentonite clay litter product at all modified starch levels from 10% to 50% (and thus starch levels from 50% to 90%). The vertical bars seen in FIG. 6 denote the standard deviation for the respective average data points.

FIG. 7A shows clump weight for exemplary litter products at varying modified starch levels, using the same simple formula as used in FIG. 6 (i.e., composite particles formed from starch and a modified starch such as dextrin). The data in FIG. 7A-7B was generated by dosing the litter product to be evaluated with 10 mL of synthetic urine, and allowing the resulting clump to set (e.g., 15 minutes). The resulting clumps were weighed and the results are reported in FIG. 7A. Low molecular weight modified starch concentrations of 0%, 5%, 10%, 15%, 20%, 25%, 30%, 35%, 40%, 50%, 60%, and 80%, with the balance being natural starch, were evaluated. As shown, modified starch concentration values of 25% and less provided clump weights that were less than the 34.3 g clump weight provided by the comparative commercial clay litter comprising limestone and bentonite clay litter product. Such reduced clump weights mean that the exemplary litter products including 10-25% modified starch are more efficient in clump formation than the comparative commercially available litter product comprising limestone and bentonite clay. The reported clump weight values are on a “wet basis”, including the weight (e.g., 10 g) of the dosing synthetic urine.

FIG. 7B shows moisture content in the clump at varying modified starch levels, illustrating how the present composite particle litter products are very efficient in clump formation, particularly at modified starch levels of up to 30%, or up to 25% (e.g., 10% to 30%, or 10% to 25% modified starch).

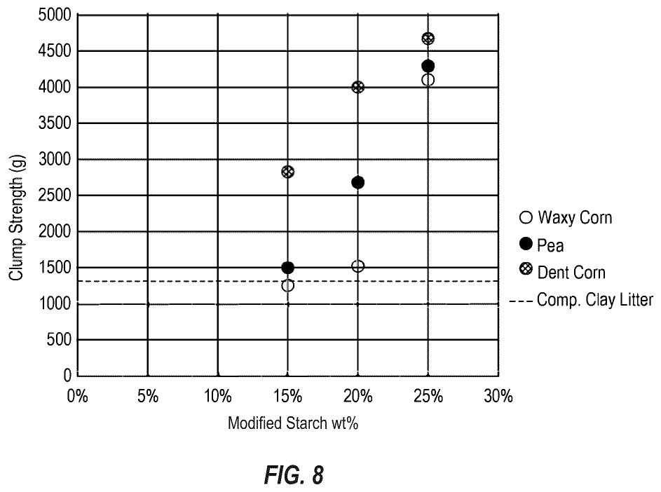

FIG. 8 shows clump strength for starches sourced from different plant materials, at varying modified starch levels. Each sample was formed from the noted starch material (not pre-gelatinized), and a wheat modified starch in the noted amount (e.g., 15%, 20%, or 25% modified starch). The horizontal line shows clump strength for the comparative commercial clay litter product comprising limestone and bentonite clay (i.e., at about 1,300 g_{f}). The results in FIG. 8 show that a variety of starches (e.g., dent corn, waxy corn, or pea) are suitable for use, to achieve good clump strength values.

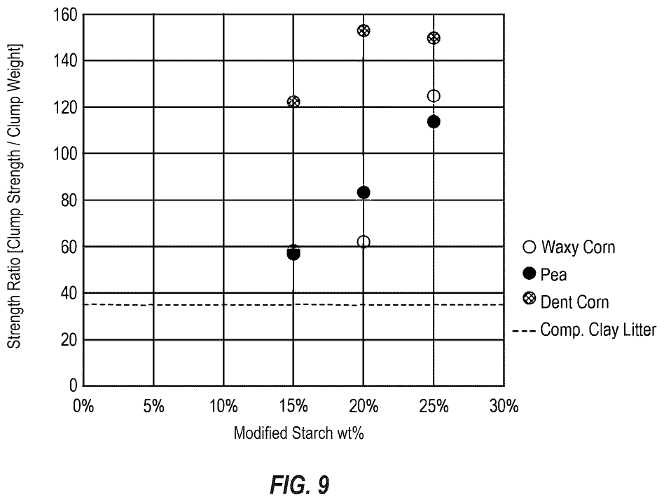

FIG. 9 shows strength ratio (clump strength to clump weight) for the same variety of different starch materials as shown in FIG. 8, at the same dextrin levels of 15%, 20%, and 25% by weight. The data in FIG. 9 normalizes clump strength for litter products providing different absorbency. The data reveal that dent corn starch performs better than waxy corn starch or pea starch, but that all such starches provide higher strength ratios than the comparative commercial clay litter product comprising limestone and bentonite clay.

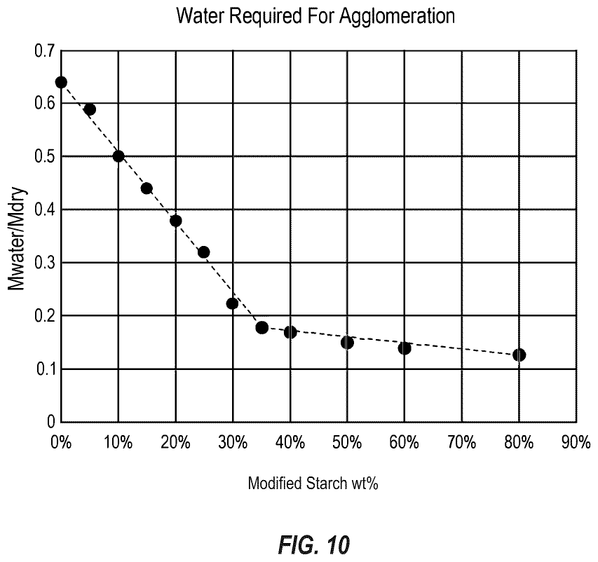

FIG. 10 shows the mass of water needed for agglomeration at various modified starch levels, to form composite litter particles as described herein. The results are plotted as the ratio of mass of water to mass of dry ingredients (e.g., starch and modified starch). As shown, the mass of water required for agglomeration is inversely proportional to the amount of modified starch, in a substantially linear relationship up to about 35% modified starch. At amounts greater than 35% modified starch, there is still an inverse relationship, although the slope of the relationship is greatly reduced. The values from FIG. 10 are recorded in Table 2 below.

TABLE 2

| | | Water % of Dry |
|---|---|---|
| Modified Starch Wt. % | Starch Wt. % | Components (M_{water}/M_{dry}) |
| 0% | 100% | 0.64 |
| 5% | 95% | 0.59 |
| 10% | 90% | 0.5 |
| 15% | 85% | 0.44 |
| 20% | 80% | 0.38 |
| 25% | 75% | 0.32 |
| 30% | 70% | 0.225 |
| 35% | 65% | 0.18 |
| 40% | 60% | 0.17 |
| 50% | 50% | 0.15 |
| 60% | 40% | 0.14 |
| 80% | 20% | 0.13 |

Comparative dusting, clump retention, absorptivity, and bulk density values for Example 2 as compared to the comparative commercial clay litter product comprising limestone and bentonite clay are shown below in Table 3.

TABLE 3

| | Example 2 | Comp. Clay Litter |
|---|---|---|
| Dust | 2.5 mg | 25 mg |
| Clump Retention | 98.6% | 91.1% |
| Absorbency (g urine/g litter) | 0.59 | 0.39 |
| Bulk Density (lb/ft³) | 37.9 | 72 |

When 10% pine wood particles were dry mixed with the Example 2 composite particles, the bulk density was reduced to 34.5 lb/ft³.

Without departing from the spirit and scope of the invention, one of ordinary skill can make various changes and modifications to the invention to adapt it to various usages and conditions. As such, these changes and modifications are properly and intended to be, within the full range of equivalence of the following claims.

1. A white clumping animal litter including a pH health indicator, the animal litter comprising:
a particulate substrate that is white, and has a substantially neutral pH, wherein the particulate substrate is configured to provide clumping of such particles when wetted during use;
pH health indicator particles admixed with the white substrate particles;
wherein the pH health indicator particles are of a first color when wetted with a substantially neutral pH liquid, wherein the pH health indicator particles are of a second color, different from the first color, when wetted with a liquid having an acidic pH, and wherein the pH health indicator particles are of a third color, different from the first and second colors, when wetted with a liquid having a basic pH; and
wherein the litter exhibits a clump retention of at least about 90%.

2. The litter of claim 1, wherein the pH health indicator particles are included within the animal litter in an amount of about 1% to about 25% by weight.

3. The litter of claim 1, wherein the pH health indicator particles are included within the animal litter in an amount of about 5% to about 15% by weight.

4. The litter of claim 1, wherein the white substrate particles are included within the animal litter in an amount of about 75% to about 99% by weight.

5. The litter of claim 1, wherein the white substrate particles are included within the animal litter in an amount of about 85% to about 95% by weight.

6. The litter of claim 1, wherein the white substrate particles comprise composite particles including starch and dextrin or another modified starch agglomerated together into the composite particles.

7. The litter of claim 6, wherein the composite particles further comprise powdered activated carbon.

8. The litter of claim 7, wherein the powdered activated carbon is present in an amount of from about 0.1% to about 5% by weight of the composite particles.

9. The litter of claim 7, wherein the powdered activated carbon is present in an amount of from about 0.25% to about 3% by weight of the composite particles.

10. The litter of claim 6, wherein the composite particles further comprise a preservative.

11. The litter of claim 10, wherein the preservative is present in an amount of up to 2% by weight of the composite particles.

12. The litter of claim 1, wherein the pH health indicator particles comprise silica gel crystals with a pH indicator.

13. The litter of claim 1, wherein substantially all components of the litter are plant-based.

14. A clumping animal litter formed from renewable components and including a pH health indicator, the animal litter comprising:
composite particles that are white, and include a substantially neutral pH, the composite particles including starch and dextrin or another modified starch agglomerated together into the composite particles;
wherein the dextrin or other modified starch comprises from about 10% to about 50% by weight of the composite particles and the starch comprises from about 50% to about 90% by weight of the composite particles;
pH health indicator particles admixed with the composite particles, wherein the pH health indicator particles are of a first color when wetted with a substantially neutral pH liquid, wherein the pH health indicator particles are of a second color, different from the first color, when wetted with a liquid having an acidic pH, and wherein the pH health indicator particles are of a third color, different from the first and second colors, when wetted with a liquid having a basic pH;
wherein the litter is substantially free of non-renewable mineral components; and
wherein the litter exhibits a clump retention of at least about 90%.

15. The litter of claim 14, wherein the pH health indicator particles are included within the animal litter in an amount of about 1% to about 25% by weight.

16. The litter of claim 14, wherein the white composite particles are included within the animal litter in an amount of about 75% to about 99% by weight.

17. The litter of claim 14, wherein the starch of the composite particles comprises natural starch.

18. The litter of claim 14, wherein the pH health indicator particles comprise silica gel crystals with a pH indicator.

19. The litter of claim 14, wherein the composite particles further comprise powdered activated carbon.

20. A clumping animal litter formed from renewable components and including a pH health indicator, the animal litter comprising:
composite particles that are white, and include a substantially neutral pH that is from about 6.5 to about 7.5, the composite particles including starch and dextrin or another modified starch agglomerated together into the composite particles;
wherein the dextrin or other modified starch comprises from about 10% to about 50% by weight of the composite particles and the starch comprises from about 50% to about 90% by weight of the composite particles;
wherein the white composite particles are included within the animal litter in an amount of about 85% to about 95% by weight;
pH health indicator particles admixed with the composite particles, wherein the pH health indicator particles are of a first color when wetted with a substantially neutral pH liquid, wherein the pH health indicator particles are of a second color, different from the first color, when wetted with a liquid having an acidic pH, and wherein the pH health indicator particles are of a third color, different from the first and second colors, when wetted with a liquid having a basic pH;
wherein the pH health indicator particles are included within the animal litter in an amount of about 5% to about 15% by weight;
wherein the litter is substantially free of non-renewable mineral components; and
wherein the litter exhibits a clump retention of at least about 90%.
